(19) United States
(12) Patent Application Publication
(10) Pub. No.: US 2007/0266075 A1
(43) Pub. Date: Nov. 15, 2007

(54) SESSION PRESENCE

(75) Inventor: JACK JACHNER, PLANO, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL, PARIS (FR)

(21) Appl. No.: 11/278,228

(22) Filed: Mar. 31, 2006

(51) Int. Cl. G06F 15/16

(52) U.S. Cl. 709/203

(57) ABSTRACT

A system, method and computer readable medium for session presence comprises collecting presence information from a session, aggregating presence information from at least one presentity and publishing the presence information of the session as a session presentity to the at least one presentity.

### BACKGROUND OF THE INVENTION

Presence is generally defined as the knowledge that a person is available via, for example, a certain device over a particular medium as soon as the user connects to the network. For instance, via presence information, it may be ascertained that the person is available online, and on a connected device with a certain device profile. Currently presence is only used to communicate the state information of a specific person or an entity. A user which indicates its presence on the network is termed a presentity. Presence is used to notify a group of watchers (users) in a contact list about the state of person, including availability. When the user changes its presence state, each contact on the contact list is informed about the new presence state of the user.

Previously, presence was associated only with the state of a person or an entity. The present invention is generally related to extending presence to a session itself, recasting sessions to take the form of a presentity allows for more varied interactions between devices, presentations and controls.

Therefore, what is needed is a system, method, and computer readable medium of extending presence to enable the session itself to take the form of a presentity, and more specifically, to represent sessions to users as presentities for the benefit of convenient and accessible display, storage and control of media sessions through clients.

### SUMMARY OF THE INVENTION

The present invention broadens presence systems and Media Session Management Systems (MSMS) (e.g. voice switches, Internet Messaging (IM) applications, video bridges, conferencing and collaboration servers, multi media session managers, and the like) by featuring sessions to users as presentities for the benefit of convenient and accessible display, storage and control of media sessions through clients to be distributed by presence systems to multiple users and devices.

Presence systems distribute the presence state of presentities (presence entities) to subscribed users (watchers) for display on a client. These presentities are typically human users with presence states such as on-line, on-the-phone or out-to-lunch.

The clients typically allow a media session to be created between two or more users, for example by one user, on his client, clicking on the corresponding icon of another user, to establish an IM, telephony, collaboration or video session. The presence state of each of the users involved in the session may then change to be “on the phone” or “using video” or “in conference.” This is the presence of the users, not media session presence.

Collaboration applications may schedule a conference to include several users; however, these applications do not provide the conference with a presence state which users can access or control from presence systems.

Classical telephony systems such as Private Branch Exchange (PBX) and key systems have the Multi Line Appearance (MLA) feature, which indicates the state of several lines on multiple terminals—each line has several states—idle, ringing, busy, on-hold, etc., and a user at a terminal can view the state of the line and may access the call by pushing the corresponding button on the terminal. Typical user behavior in a small office includes the following steps: the terminals ring, one of the users answers, inquires about the destination user of the call, puts the caller on hold, and communicates verbally to the appropriate user such as, “Bob, call for you on line 2.” MLA displays and controls voice telephony states of the line, which is much more restrictive than the session and which is not tied to lines, (e.g. a user may change devices during a session), and not tied to voice as media (IM, collaboration, video, in combination). These MLA features are also implemented in proprietary PBX and key systems.

Call centers associate incoming customer calls with prior customer interaction data using Customer Relationship Management (CRM) applications. The association is performed using the customer calling number, and/or customer entered customer identification data. This call associated data is then provided to the customer service agent, or multiple agents as required to process the customer call, so that the agents have additional information to improve customer service. This call associated data is not linked to presence systems in existing call center systems.

The basic premise is to link media session management systems with presence systems to represent media sessions as presentities to users of a presence system, for session viewing and control through a presence system client.

The presence of a media session is rich, as it is composed of many elements of the session, such as current session state (scheduled, initiating, on-going, leader speaking, ad hoc), number of participants (total invited, currently attending, number active vs. passive), identifying information on participants (name, telephone number), presence of each participant, as it relates to the session (e.g. each has video capability), media comprising the session (IM, voice, video, document sharing, and combinations), session subject or title (weekly staff meeting), and session associated information, in the call center scenario (CRM info). The rich session presence may be distributed and stored as extensible Markup Language (XML). Session presence may be used for the information of users or to control applications and systems.

The presence of sessions is published to a session specific presence agent within a rich presence server which aggregates presence information from the media session manager, from each user presence agent, from each client of each user and from other presence information sources. The presence information of sessions is published to watchers of the session presence agent. These watchers may have subscribed permanently to associated sessions, or may be added based on the identity of the participants of the session. The watchers may include the participants in the session, their administrative assistants, their supervisors, logging applications, accounting applications, security applications, and media session management systems.

The session presence information may be filtered so only specific watchers of the session presence agent receive restricted rich presence information, for privacy, policy and security reasons.

The present invention permits implementation of several interesting use cases for multimedia session management such as, session presentation to inform the user of session events such as a session invitation (incoming call) on a session involving the user, that is watched by the user (my office and/or home phone and IM accounts as my buddies) on a presence user interface on a device (Personal Computer (PC), telephone, cellular phone, and the like) connected to a presence system. Another multimedia session management tool can be utilized such as session control, by interacting with the presence user interface, the user may optionally control the session management system through the client (click on session buddy line during session presentation to accept the invitation to join the session). Another case would be to allow remote viewing and control of multiple sessions from a client, such as for attendant stations, and for MLA telephony switch functions. The invention would extend the attendant and MLA functions beyond voice to a media session on a terminal (video, IM, application sharing). Additionally, the invention would allow integration of functionality, and facilitate user control of disparate telephony systems, such as PBXs, soft phone clients, fixed phones and mobiles via presence system infrastructures. Another case would associate session related information to the session as rich presence, so that new participant to the session (from a transfer or conference function) may also access the associated session information via a presence system, or transfer sessions to other users on the presence system.

In one embodiment of the invention a method for session presence comprises collecting presence information from a session, aggregating presence information from at least one presentity and publishing the presence information of the session as a session presentity to the at least one presentity. The collection of presence information from a session may be performed by a session presence agent; the aggregation of presence information is from a client of the at least one presentity. The method may additionally comprise the steps of managing a plurality of sessions between presentities, wherein the managing of a plurality of sessions between presentities may occur through a client. The method may include viewing remotely at least one session presentity through a client, controlling remotely at least one session presentity through a client, subscribing to the session presence agent as a session presence watcher, providing the session presentity information to the at least one presentity, integrating of presentities with disparate functionality to the session presence aggregation wherein presence information contains rich presence information and transferring the session presence to the at least one presentity.

In another embodiment of the invention a computer readable medium comprises instructions for linking a media session management system to a presence system and assigning session presentity to a session. The computer readable medium may also comprise instructions for viewing the session presentity on a client, controlling the session presentity on a client, aggregating presence information by a session presence agent and publishing presence information by a session presence agent.

In yet a further embodiment of the invention, a presence system enabled media session management system including a presence server for collecting presence information and distributing the presence information to one or more watchers, comprises a media session management system for managing a plurality of communication sessions between users and publishing presence information thereof, a session presence agent within the presence server in communication with the media session management system for collecting the published session presence information and the session presence agent further aggregating other presence information comprising at least one of user presence information, presence information from each client of each user, and from other presence information sources for each user, the aggregated presence information is provided to watchers subscribed to the session present agent as a session presence watcher. The system presence information may also comprise a filtering system to restrict the availability of secure information, a logging system to record session presence events and session associated data, and an accounting system to track costs associated with session usage.

### BRIEF DESCRIPTION OF THE DRAWINGS

FIG. 1 depicts a first session presence system in accordance with a preferred embodiment of the present invention;

FIG. 2 depicts a second session presence system in accordance with a preferred embodiment of the present invention;

FIG. 3 depicts a session presence method flow block in accordance with a preferred embodiment of the present invention;

FIG. 4 depicts a first session presence software flow block in accordance with a preferred embodiment of the present invention;

FIG. 5 depicts a second session presence software flow block in accordance with a preferred embodiment of the present invention; and

FIG. 6 depicts a third session presence system in accordance with a preferred embodiment of the present invention.

### DETAILED DESCRIPTION OF THE INVENTION

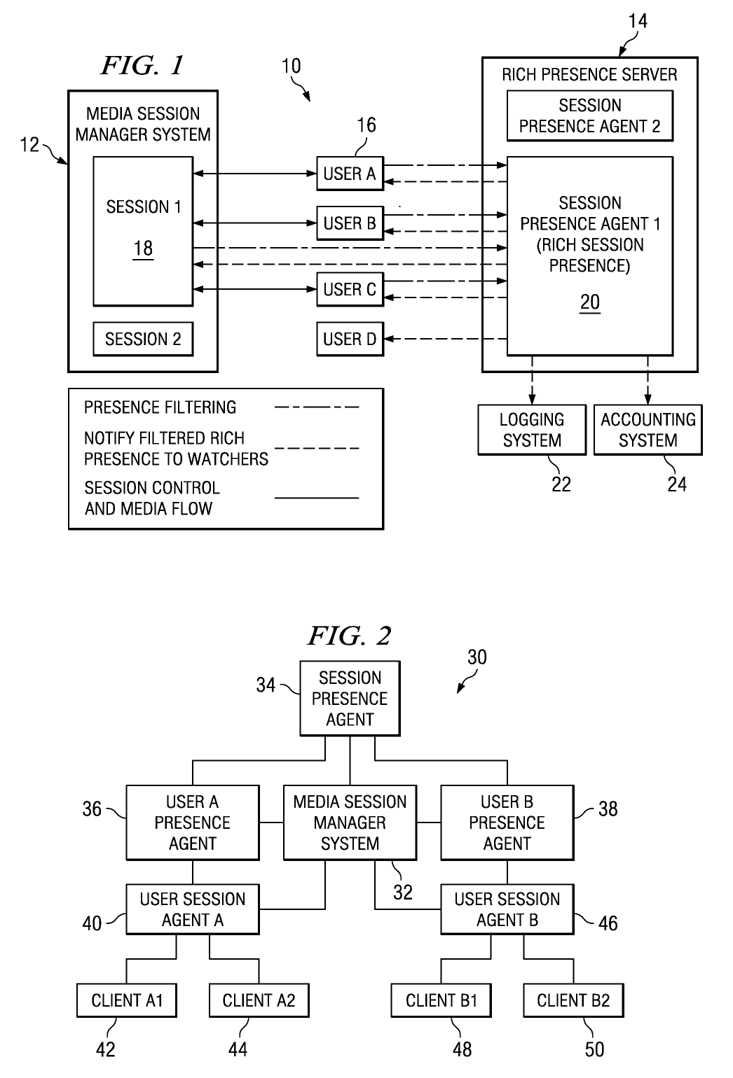

Referring now to FIG. 1, a first session presence system 10 is depicted and includes a number of modules such as a presence enabled media session management system 12 which includes a presence server 14 for collecting presence information and distributing the presence information to one or more watchers also known as users 16, a media session management system for managing a plurality of sessions 18 between users and publishing presence information thereof, a session presence agent 20 within the presence server in communication with the media session management system for collecting the published session presence information. The session presence agent 20 further aggregates other presence information comprising at least one of user presence information, presence information from each client of each user, and from other presence information sources for each user. The aggregated presence information is provided to watchers subscribed to the session present agent as a session presence watcher. The system may also include filtering function in the rich presence server 14 to restrict the availability of secure information, a logging system 22 to record session presence events and session associated data, and an accounting system 24 to track costs associated with session usage.

For example, the presence infrastructure may be accessed by a cellular phone, a PC with external wireless capability (such as a wireless card) or internal wireless capability (such as via 802.11 or any of the other 802 variants), by an Internet Protocol enabled device, or other electronic devices adapted to transmit and/or receive information to and/or from the presence infrastructure. These modules are software, hardware, firmware, and/or a combination of software, hardware, and/or firmware. The communications coupling occurs via at least one of the wireless protocol, the wired protocol and a combination of the wireless protocol and the wired protocol.

Referring now to FIG. 2, a second session presence system 30 is shown. A media session manager system 32 is in communication with a session presence agent 34 which in turn communicates with user A presence agent 36 and user B presence agent 38. The user A presence agent and user B presence agent are in communication with the media session manager system. Additionally the user A presence agent is in communication with user session agent A 40 which is in communication with clients A1 42 and A2 44. User B presence agent is in communication with user session agent B 46 which is in communication with clients B 1 48 and B2 50. The user A session agent and user B session agent are also in communication with the media session manager system. The present invention links the media session management system with the presence system to assign a presentity to the media session itself. Assigning presentity status to the MSMS allows for session viewing and control through a presence system client. The modules in this figure are performed by software, hardware, firmware, and/or the combination of software, hardware, and/or firmware. The transfer of information of the information exchange state of the presence message occurs via at least one of a wireless protocol, a wired protocol and a combination of the wireless protocol and the wired protocol.

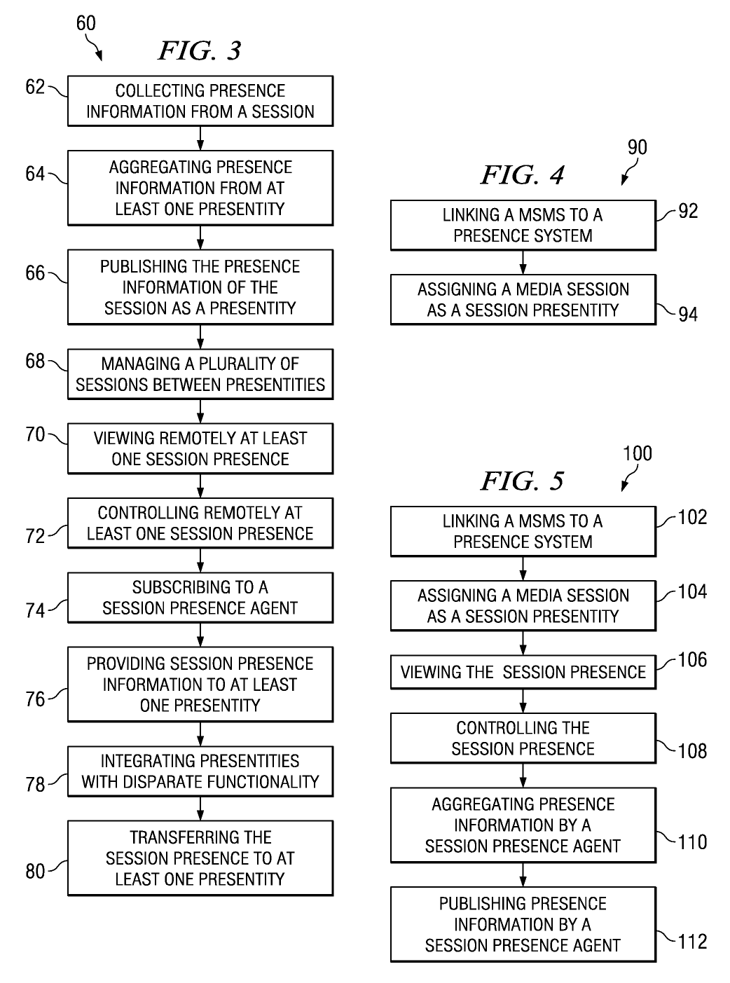

Referring now to FIG. 3, a flow block of the method of session presence 60 is shown. This method for session presence comprises collecting 62 presence information from a session, aggregating 64 presence information from at least one presentity and publishing 66 the presence information of the session as a session presentity to the at least one presentity. The collection of presence information from a session may be performed by a session presence agent the aggregation of presence information is from at least one of a presentity and a client of the at least one presentity. The method may additionally comprise the steps of managing 68 a plurality of communication sessions between presentities, wherein the managing of the plurality of communication sessions between presentities may occur through a client. The method may include viewing 70 remotely at least one session presence through a client, controlling 72 remotely at least one session presence through a client, subscribing 74 to a session presence agent as a session presence watcher, providing 76 the session presentity information to the at least one presentity, integrating 78 of presentities with disparate functionality to the session presence aggregation wherein presence information contains rich presence information and transferring 80 the session presence to the at least one presentity. For example, the presence infrastructure may be accessed by a cellular phone or a computer with external wireless capability (such as the wireless card) or internal wireless capability (such as 802.11 or any of the other 802 variants), by an Internet Protocol enabled device, or other electronic devices adapted to transmit and/or receive information to and/or from the presence infrastructure. The steps performed in this figure are performed by software, hardware, firmware, and/or the combination of software, hardware, and/or firmware. The transfer of information between agents and clients occurs via at least one of a wireless protocol, a wired protocol and the combination of the wireless protocol and the wired protocol.

Referring now to FIG. 4, a first software flow block of the method of session presence 90 is shown. A computer readable medium (or software) comprises instructions for linking 92 a media session management system to a presence system and assigning 94 session presentity to a session. The steps performed in this figure are performed by software, hardware, firmware, and/or the combination of software, hardware, and/or firmware. The transfer of information of the information exchange state of the presence message occurs via at least one of a wireless protocol, a wired protocol and a combination of the wireless protocol and the wired protocol.

Referring now to FIG. 5, a third software flow block of the method of session presence 100 is shown. A computer readable medium comprises instructions for linking 102 a media session management system to a presence system and assigning 104 session presentity to a session. The computer readable medium may also comprise instructions for viewing 106 the session presentity on a client, controlling 108 the session presentity on a client, aggregating 110 presence information by a session presence agent and publishing 112 presence information by a session presence agent. The steps performed in this figure are performed by software, hardware, firmware, and/or the combination of software, hardware, and/or firmware. The transfer of information of the information exchange state of the presence message occurs via at least one of a wireless protocol, a wired protocol and a combination of the wireless protocol and the wired protocol.

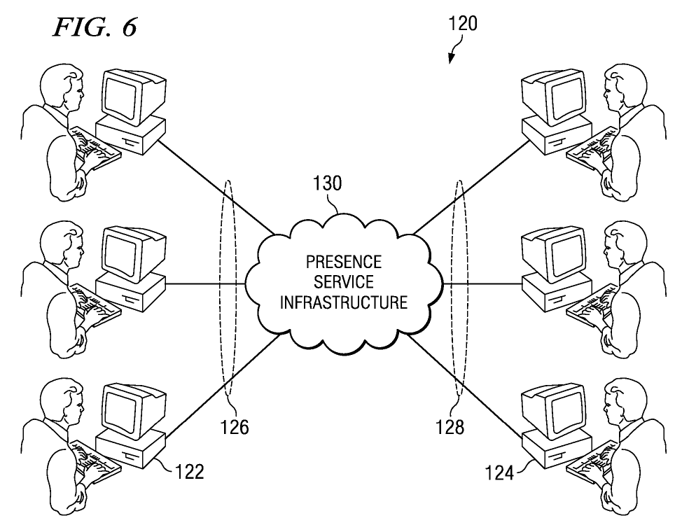

Referring now to FIG. 6, a system of session presence 120 is shown. The users 122, 124 are presentities 126 and 128 that interact with the session presentity 130. In this way the interaction broadens between the users and the session presence. For example, the presence infrastructure may be accessed by the cellular phone or a PC with external wireless capability (such as the wireless card) or internal wireless capability (such as 802.11 or any of the other 802 variants), or by the Internet Protocol enabled phone. Other devices may also communicate with the presence infrastructure. These modules are software, hardware, firmware, and/or the combination of software, hardware, and/or firmware. The communications coupling occurs via at least one of a wireless protocol, a wired protocol and a combination of the wireless protocol and the wired protocol.

The present invention includes computer readable medium or software that is preferably stored on the presence server. In other embodiments, the software of the present invention can be stored on the presentity, the watcher or a combination of at least two of the presence server, the presentity, and the watcher. Such a computer readable medium comprises instructions for performing the functionality described in relation to FIGS. 1-6 and for assigning the presentity to the media session manager system.

Although the exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the modules. Also, these capabilities may be performed in the current manner or in the distributed manner and on, or via, a device able to direct presence messages to targeted watchers. Further, although depicted in the particular manner, various modules may be repositioned without departing from the scope of the current invention. For example, some or all of the modules could be united into one of the modules or into a new module (not shown). Still further, although depicted in the particular manner, the greater or lesser number of users, watchers and presence infrastructures could be utilized.

Further, a lesser or greater number of information exchange states may be utilized with the present invention and such presence messages may include complementary information in order to accomplish the present invention, to provide additional features to the present invention, and/or to make the present invention more efficient.

What is claimed is:

1. A method of assigning session presence in a presence system, comprising:
collecting presence information from a session;
aggregating presence information from at least one presentity; and
publishing the presence information of the session as a session presentity to the at least one presentity.

2. The method of claim 1 wherein the collection of presence information from a session is performed by a session presence agent.

3. The method of claim 1 wherein the aggregation of presence information is from a client of the at least one presentity.

4. The method of claim 1 comprising managing a plurality of sessions between presentities.

5. The method of claim 4 wherein the managing of a plurality of sessions between presentities may occur through a client.

6. The method of claim 1 comprising viewing remotely at least one session presentity through a client.

7. The method of claim 1 comprising controlling remotely at least one session presence through a client.

8. The method of claim 2 comprising subscribing to the session presence agent as a session presence watcher.

9. The method of claim 2 comprising providing the session presentity information to the at least one presentity.

10. The method of claim 1 comprising integration of presentities with disparate functionality to the session presence aggregation.

11. The method of claim 1 wherein presence information contains rich presence information.

12. The method of claim 1 comprising transferring the session presence to the at least one presentity.

13. A computer readable medium comprising instructions for:
linking a media session management system to a presence system; and
assigning session presentity to a session.

14. The computer readable medium of claim 13 comprising instructions for viewing the session presentity on a client.

15. The computer readable medium of claim 13 comprising instructions for controlling the session presentity on a client.

16. The computer readable medium of claim 13 comprising instructions for aggregating presence information by a session presence agent.

17. The computer readable medium of claim 13 comprising instructions for publishing presence information by a session presence agent.

18. A presence system enabled media session management system including a presence server for collecting presence information and distributing the presence information to one or more watchers, comprising:
a media session management system for managing a plurality of communication sessions between users and publishing presence information thereof;
a session presence agent within the presence server in communication with the media session management system for collecting the published session presence information; and
said session presence agent further aggregating other presence information comprising at least one of user presence information, presence information from each client of each user, and from other presence information sources for each user, said aggregated presence information provided to watchers subscribed to the session present agent as a session presence watcher.

19. The system of claim 18 further comprising a logging system to record session presence events and session associated data.

20. The system of claim 18 further comprising an accounting system to track session costs.

21. The system of claim 18 further comprising a filtering system to restrict the availability of secure information.
